(19) United States
(12) Patent Application Publication
(10) Pub. No.: US 2023/0398860 A1
(43) Pub. Date: Dec. 14, 2023

(54) Container, in Particular for a Fluid, and Method for Producing a Container

(71) Applicant: Bayerische Motoren Werke Aktiengesellschaft, Muenchen (DE)

(72) Inventors: Emmanuel ARRAS, Muenchen (DE); Michael BUHL, Grafing (DE); Florian-Alexander DRASCH, Muenchen (DE); Attila FARKAS, Muenchen (DE); Wolfgang LIEBHART, Muenchen (DE)

(21) Appl. No.: 18/033,617

(22) PCT Filed: Oct. 19, 2021
(86) PCT No.: PCT/EP2021/078869

§ 371 Date: Apr. 25, 2023

(30) Foreign Application Priority Data
Nov. 12, 2020 (DE) 10 2020 129 893.5

(51) Int. Cl. B60K 15/073

(52) U.S. Cl. CPC B60K 15/073; B60K 2015/03032

(57) ABSTRACT

A container for storing a fluid may have one or more of the following features: container walls which define a cavity for storing the fluid, and a positioning system via which at least one component inside the cavity can be positioned in a guided manner.

### BACKGROUND AND SUMMARY

The present invention relates to a container, in particular for a fluid, and to a method for producing a container.

Fuel containers in which all of the components required for conveying fuel and preparing fuel are disposed outside the fuel container are known from the prior art. This is associated with the disadvantage that many emission-relevant connection points are exposed. Moreover, fuel containers in which many components required for conveying fuel and preparing fuel are integrated in the fuel container per se are known. These components include, for example, the fuel pump, fuel filters, pressure regulators, valves, etc. The integration in the interior of the fuel container is not without problems in the event of maintenance or damage because the accessibility into the interior of the fuel container is limited and a potentially defective component cannot be removed from the fuel container with a justifiable level of complexity. The internal disposal of the parts/components of the fuel system also presents a challenge in the production of the fuel tanks since, depending on the shape of the container, it is potentially not possible for the components to be disposed in a desirable region of the fuel container because the latter by virtue of the geometry thereof is inaccessible or accessible only with great difficulty. This problem is amplified in that modern vehicle architectures are increasingly being developed for electrically driven vehicles and the installation space for fossil energy stores no longer represents a primary objective, the degree of freedom in terms of design being further restricted as a result.

It is an object of the present invention to specify a container, in particular for a fluid, and a method for producing a container, wherein the aforementioned problems are to be eliminated and the flexibility of the known systems is to be enhanced.

This object is achieved by a container, and by a method related to the container. Further advantages and features are derived from the claims, the description, and the appended figures.

The invention relates to a container, in particular for a fluid, wherein the container has a container wall assembly which forms a disposal space for storing a fluid; and wherein the container comprises a positioning system by way of which at least one component within the disposal space is able to be positioned in a guided manner. In this way, it is advantageously possible to move the at least one component even to regions or locations within the container that are difficult to access, in particular in a guided manner, and to dispose the at least one component there. This enables degrees of freedom in terms of the construction and the design of the container. Besides, great advantages in terms of the maintenance and servicing of the container are also derived as a result, because the positioning system also has the effect that one or a plurality of components can be removed from the container again while being mounted in a guided manner.

According to one preferred embodiment, the container is a fuel container or a fuel tank, in particular for motor vehicles. The at least one component is, for example, a fuel supply component. A fuel supply component may be an in particular electrically driven fuel pump, a fuel filter, a fuel level sensor, a fuel feed line, as well as electrical components such as electric current supply conductors. A multiplicity of components of this type can preferably be displaced and disposed in a guided manner by way of the positioning system. The sum of the aforementioned components forms a fuel supply module. In the present case, a fuel supply module as a tank-installed unit can expediently be positioned in or displaced to a desirable or envisaged position/location within the fuel container and be locked in place or fastened in the latter by way of the positioning system in the fuel container.

According to one embodiment, the container is a windshield washer system container or an SCR tank (selective catalytic reduction), or generally a container or tank for a liquid, for example. The preferred container types are not limited to the aforementioned examples.

According to one embodiment, the fluid in question is a liquid fuel, in particular a liquid gasoline or diesel fuel. Alternatively, the fluid is a gaseous fluid, or a mixture of a liquid and a gaseous fluid.

According to one embodiment, the positioning system is fastened to, or configured on, the container wall assembly, in particular on an interior on the container wall assembly, in other words on an internal wall. The positioning system is preferably fastened in a form-fitting and/or force-fitting and/or materially integral manner, for example with a screw-fitting, riveting, adhesive bonding and/or welding. The fastening can take place from the outside and/or from the inside.

The positioning system is expediently conceived to enable a guided displacement of one or a plurality of components. The positioning system is in particular conceived such that the components can be moved or displaced relative to the container wall assembly, in order for the components to be brought to an envisaged or predetermined or desirable position within the container, or to retrieve them from there, for example in the event of service or maintenance.

According to one preferred embodiment, the positioning system comprises at least one guide element by way of which the at least one component is mounted so as to be movable, in particular displaceable, or is able to be positioned in a guided manner. The guide element is expediently conceived such that the component(s) can be displaced in a sliding and guided manner along the guide element. The guide element is expediently configured as a rail or rail element, wherein the at least one rail can be constructed from straight rail elements and/or arcuate elements, or curved elements, respectively. According to one embodiment, the positioning system comprises a multiplicity of guide elements which are disposed so as to be distributed in the container. The rails per se can in each case be integrally configured, or in one part. Alternatively, the rails can be configured in multiple parts and formed from individual segments which are individually assembled so as to form a desired shape of rail.

The disposal of the at least one rail, or the profile of the latter, can be routed along the container wall and/or so as to be spaced apart from the latter such that all of the locations/regions within the container can advantageously be covered or reached. In spatial terms, one or a plurality of rails can at least in portions run at the bottom, laterally, at the top and/or centrically in relation to the container.

The material of the positioning system, in particular of the at least one guide element, is advantageously based on the material of the container, or of the container wall assembly. If the container is produced from a non-metallic material such as, for example, a plastics material, a non-metallic material, in particular a plastics material, for example, is expediently used for the positioning system, or the guide element. Accordingly, if the container is formed from a metallic material, a metallic material is expediently used for the positioning system, or the guide element.

According to preferred embodiments, the rails are formed or constructed as, for example, I-beams, H-beams, or the like. The geometry of the aforementioned beams advantageously enables correspondingly prepared components to be guided in a form-fitting manner. The at least one guide element expediently has a first guide structure by way of which the at least one component is mounted, in particular in a form-fitting manner. The actual geometric design embodiment has to be conceived as a function of the specific individual case. The disposal of, or the connection between, the guide element and the corresponding component is expediently designed in such a manner that a preferably sliding displacement of the component is possible along the guide element, in particular the rail, wherein the component is fixed or held transversely to the latter. For example, an undercut or the like, which is provided for interacting with a component to be fastened, is provided at a location on the guide element where a component is to be fastened. The latter can latch into the undercut and is securely fixed therein, for example. The connection is preferably configured so as to be releasable such that a component can also be removed again.

According to one embodiment, the positioning system comprises at least one sliding element which is disposed on the container wall assembly and by way of which the guide element is able to be disposed in a guided manner in the container, or also be removed again. According to one embodiment, the at least one guide element remains in the container. The at least one component is positioned by way of the guide element and is fastened thereto. The at least one component is thus fastened to or held on the guide element. To this end, the guide element, in particular the first guide structure, can have at least one undercut with which a suitable geometry of the at least one component interacts, or vice versa, such that the at least one component is fastened to the guide element.

Alternatively, a guide element is releasably fastened. The guide element may also be referred to as a temporary (auxiliary) rail. It can thus be removed again once the at least one component has been disposed. The fastening of the at least one component is not performed on the respective guide element. The guide element expediently comprises a second guide structure which is conceived to interact with the at least one sliding element such that the guide element is able to be assembled and disassembled in a guided manner. A plurality of sliding elements are preferably provided, wherein the latter, according to a preferred embodiment, are configured in the shape of pins. The guide element can be pushed into the container, or removed therefrom, along the pins.

According to one embodiment, the at least one component is fastened to or held on the at least one sliding element. To this end, the component comprises a holding structure which is conceived to interact with the first guide structure. When the guide element is removed, the holding structure can clip onto the, for example pin-shaped, sliding element. According to one embodiment, the holding structure to this end comprises a multiplicity of clip-fit or gripping elements which are able to expand, for example, and for fastening enable a form-fitting interaction with the first guide structure as well as a form-fitting and/or force-fitting interaction with the sliding elements, when the guide element is removed.

The container wall assembly, or the container, expediently has a service opening or an access, wherein the positioning system, in particular the at least one guide element, reaches up to the service opening. Good accessibility is ensured in this way. The components can be introduced and expediently also retrieved from the fuel container again by way of the access, or service opening.

According to one embodiment, the components within the container form an in particular contiguous and mutually fixed unit. The latter is expediently designed in such a manner that, by fastening one component, the complete unit is fixed. The component that is used for fastening is expediently positioned in the region of the access, as a result of which the component in the event of a service can be reached and the fastening released without great complexity.

According to one embodiment, the container wall assembly is configured so as to be cylindrical. The container wall assembly is preferably configured as an extruded section. This expediently represents a very cost-effective design embodiment because an extruded section of this type can be made available as bulk stock and can advantageously be cut to a desired length. The cylindrical or tubular, in particular elongate, design potentially hampers the disposal of components within the fuel container, but this problem can advantageously be solved by way of the positioning system such that an overall very cost-efficient fuel tank can be provided.

According to one embodiment, the cylindrical container wall assembly, in particular the container wall assembly which in the cross section is round, in particular circular, is flattened or ovalized in a downstream process step, as a result of which the utilization of space can potentially be optimized. The disposal of components within a fuel container shaped in such a manner may be hampered by the changing cross section. However, this problem is advantageously solved by way of the proposed positioning system because the latter enables access to locations that are difficult to reach.

Using a positioning system of this type it is in particular possible for components to be disposed around a corner or a curve, for example, in particular thus at a position or a location within the container which is no longer visible from the service opening or from the access of the fuel container.

The positioning system can be fastened to the container wall assembly before the latter has the final shape of the container, but alternatively also in a subsequent process or method step.

The invention also relates to a method for producing a container, the method comprising the following method steps:
providing a container wall assembly for forming a container;
disposing a positioning system on the container wall assembly for introducing at least one component into the container;
positioning at least one component within the container by way of the positioning system.

The at least one component can expediently be pushed to a desired location within the container with the positioning system.

As a result, many degrees of freedom relating to the shape of the container are expediently derived. The positioning system advantageously also enables the accessibility of locations within a container that are difficult to access in order for components to be disposed. It is to be mentioned at this point that the advantages and features mentioned in the context of the container apply in an analogous and corresponding manner to the method.

### BRIEF DESCRIPTION OF THE DRAWINGS

Further advantages and features are derived from the description hereunder of embodiments of containers with reference to the appended figures.

In the figures:

FIGS. 1 and 2 show two schematic views of an embodiment of a container in a sectional illustration during the disposal of a component;

FIG. 3 shows two embodiments of containers, in sectional illustration along an insertion direction;

FIG. 4 shows a further schematic plan view onto an embodiment of a container; and

FIGS. 5 and 6 show an embodiment of a container comprising a releasable guide element.

### DETAILED DESCRIPTION OF THE DRAWINGS

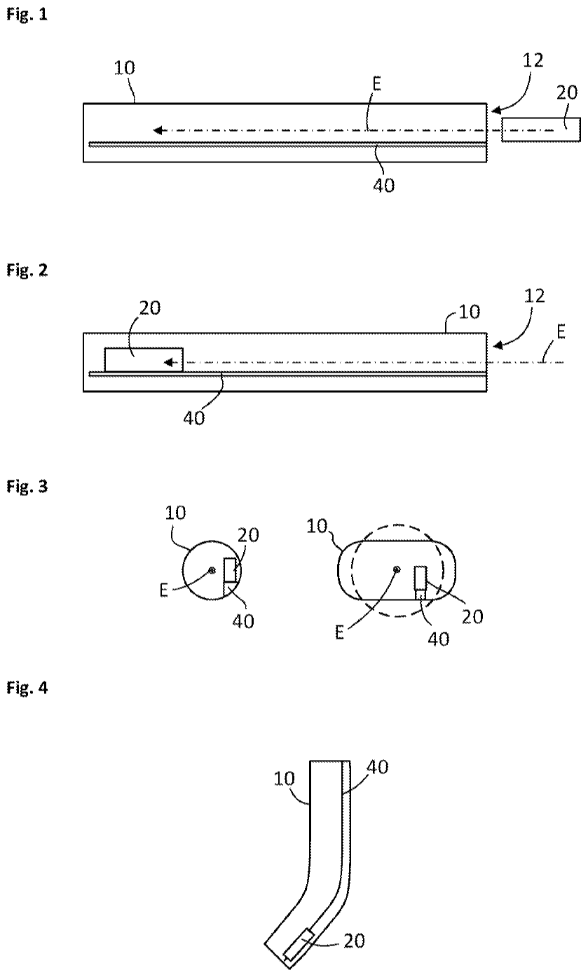

FIG. 1 in a schematic sectional view shows an embodiment of a container comprising a container wall assembly 10. It is schematically illustrated that a positioning system, presently a diagrammatic linear guide element 40, is disposed within the container. This guide element 40, by way of an access opening 12 of the container, or of the container wall assembly 10, respectively, enables a component 20 to be disposed along an insertion direction E within the container; cf. FIG. 2 in this regard.

FIG. 2 shows the arrangement known from FIG. 1, wherein the component 20 is introduced along the insertion direction E up to a predefined position. The positioning system, or the guide element 40, respectively, is expediently conceived to fix, to hold or to lock the component 20 in this position, in other words to fasten the component 20 in this position. To this end, the positioning system comprises a correspondingly configured locking mechanism, for example. The locking mechanism is expediently able to be remote controlled. For example an activating element which causes the component 20 to be fastened as well as released at this location is provided in the region of the access opening 12. The activating element can also provide a function by way of which the removal of the component from the container is made possible. For example, a component of this type can be extracted from this position by way of a corresponding traction element, etc.

FIG. 3 shows two further views of containers, in a sectional illustration transverse to an insertion direction E. It can be seen in the left half of the image that a container wall assembly 10 has a substantially cylindrical, in particular round or circular, shape. This here is preferably an extruded section which is advantageous from the point of view of costs. A positioning system comprising a guide element 40 is disposed on or fastened to the inside of the container wall assembly so as to be laterally at a central height level, wherein a component is positioned or fastened by way of this guide element 40. It is schematically illustrated in the right half of the image that a circular container wall assembly 10 of this type can be formed, for example to an ovalized shape, by way of a forming process, for example. The positioning system is expediently entirely independent of the shape of the container wall assembly 10, or is conceived in such a manner that the positioning system adapts itself to the shape of the container wall assembly; cf. also FIG. 4.

FIG. 4 in a schematic sectional illustration and a plan view shows a container having a container wall assembly 10, wherein the container wall assembly 10 forms a curve or a kink. A guide element 40 is configured along the container wall assembly 10, thus following the shape of the latter and enabling a component 20 to be displaced in a guided manner, even into a region which is difficult to access, as schematically shown here.

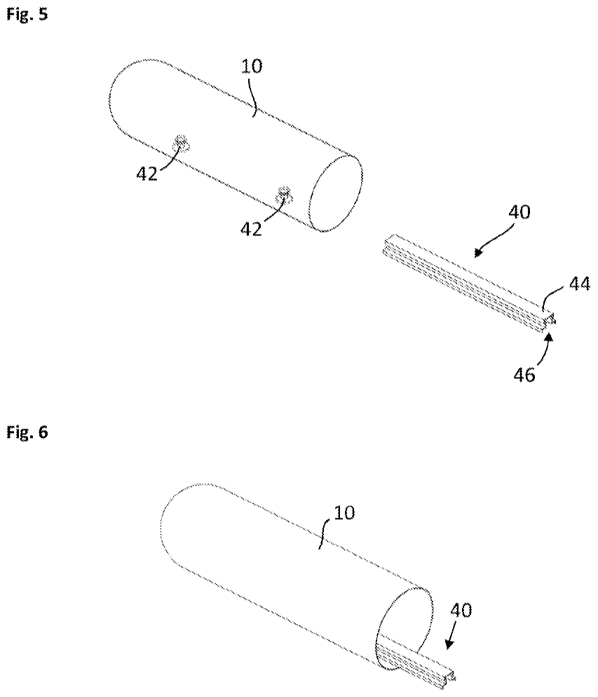

FIG. 5 shows an embodiment of a container, comprising a container wall assembly 10. Two sliding elements 42 are disposed in the interior. These two sliding elements 42 are expediently shaped in such a manner that they can interact in a form-fitting manner with a second guide structure 46 of a guide element 40. According to one embodiment, the sliding elements 42 are configured as pins. The second guide structure 46 presently has a groove-shaped design embodiment. The guide element 40, while guided by way of the sliding elements 42, can advantageously be disposed in the container and also be removed from the latter again; cf. FIG. 6 in this regard. A component (not illustrated here) can be guided into the interior of the container by way of the guide element 40, in particular by way of the first guide structure 44 thereof. The component can be fastened directly to one of the sliding elements 42, for example. To this end, the guide element 40 can be correspondingly removed. The guide element 40 can also remain in the container. The guide element 40 can also be used for fastening the component.

### LIST OF REFERENCE SIGNS

10 Container wall assembly
12 Access, service opening
20 Component
40 Guide element
42 Sliding element
44 First guide structure
46 Second guide structure
E Insertion direction

1.-10. (canceled)

11. A container, comprising:
a container wall assembly which forms a disposal space for storing a fluid; and
a positioning system, wherein the positioning system is configured such that at least one component within the disposal space is moveable in a guided manner.

12. The container according to claim 11, wherein the positioning system is configured to be fastened to the container wall assembly.

13. The container according to claim 11, wherein the positioning system comprises at least one guide element configured to position the at least one component in a guided manner.

14. The container according to claim 13, wherein the guide element includes a straight and/or arcuate rail element.

15. The container according to claim 13, wherein the positioning system comprises at least one sliding element which is disposed on the container wall assembly, and wherein the guide element is secured to the container wall assembly via the at least one sliding element.

16. The container according to claim 13, wherein the at least one component is secured to the guide element.

17. The container according to claim 15, wherein the at least one component is secured to the at least one sliding element.

18. The container according to claim 11, wherein the container wall assembly is cylindrical at least in part.

19. The container according to claim 11, wherein the container wall assembly includes an extruded section.

20. A method for producing a container, the method comprising the following steps:
providing a container wall assembly for forming a container;
disposing a positioning system on the container wall assembly for introducing at least one component into the container; and
positioning at least one component within the container by way of the positioning system.

21. A container, comprising:
a container wall assembly which forms a disposal space for storing a fluid; and
a positioning system; and
a component located at least partially within the disposal space, the component being moveable within the disposal space in a guided manner.

22. The container according to claim 21, wherein the positioning system is secured to the container wall assembly.

23. The container according to claim 21, wherein the positioning system comprises a guide element that guides a motion of the component within the disposal space.

24. The container according to claim 23, wherein the guide element includes a straight and/or arcuate rail element.

25. The container according to claim 23, wherein the positioning system comprises a sliding element which is disposed on the container wall assembly.

26. The container according to claim 25, wherein the guide element is secured to the container wall assembly at least partially via the sliding element.

27. The container according to claim 23, wherein the at least one component is secured to the guide element.

28. The container according to claim 25, wherein the component is secured to the sliding element.

29. The container according to claim 21, wherein the container wall assembly is cylindrical.

30. The container according to claim 21, wherein the container wall assembly includes an extruded section.
